(19) United States
(12) Patent Application Publication
(10) Pub. No.: US 2020/0409951 A1
(43) Pub. Date: Dec. 31, 2020

(54) Intelligence Augmentation System for Data Analysis and Decision Making

(71) Applicants: Michael Kowolenko, Cary, NC (US); John C. Bass, Cary, NC (US); Meaghan E. Johnson, Cary, NC (US); Andrew Brown, Cary, NC (US); Michael S. Brown, Cary, NC (US); Jesse Simpson, Cary, NC (US)

(72) Inventors: Michael Kowolenko, Cary, NC (US); John C. Bass, Cary, NC (US); Meaghan E. Johnson, Cary, NC (US); Andrew Brown, Cary, NC (US); Michael S. Brown, Cary, NC (US); Jesse Simpson, Cary, NC (US)

(21) Appl. No.: 16/453,805

(22) Filed: Jun. 26, 2019

(51) Int. Cl. G06F 16/2458; G06N 20/00; G06F 16/2453

(52) U.S. Cl. CPC G06F 16/2465; G06F 16/2453; G06N 20/00

(57) ABSTRACT

A system for the dynamic analysis of unstructured data where feedback loops exist between the user and the machine resulting in improved specificity and content (accuracy and precision) with regard to the results obtained from the machine learning algorithms. A Graphic User Interface (GUI) controls the configuration and deployment of all the features of the Intelligence Augmentation System (IAS) including data capture and processing, analytics, and feedback. Results of one set of algorithms can be forwarded to subsequent tools with the system for further analysis and planning using decision algorithms. The results are configured using a GUI that can manipulate the data in dynamically, allowing immediate visualization of user queries.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyrights whatsoever.

### BACKGROUND

Data Mining is the process of extracting insight from large amounts of structured data where features have been predefined. This type of data is often found in databases and collections of databases (e.g. data warehouses). Textual or unstructured data such as free formed text where features are derived by the reader familiar with the content and context of the words written in documents can be mined for content classification or fact extraction. Unfortunately, many software systems for analytics and machine learning focus on specific domains. The challenge is designing a system that can be used by business users with little experience in data sciences to extract relevant information and perform analysis and visualization of the results.

Unstructured text data mining is often used by business intelligence organizations to capture public perceptions regarding products, events, etc. It has been used in healthcare to extract information from electronic medical records, and in law enforcement to extract information regarding crimes.

### BRIEF DESCRIPTION OF THE DRAWINGS

Certain illustrative embodiments illustrating organization and method of operation, together with objects and advantages may be best understood by reference to the detailed description that follows taken in conjunction with the accompanying drawings in which:

FIG. 1 is a view of an Intelligence Augmentation System (IAS) features consistent with certain embodiments of the present invention.

FIG. 2 is a view of the IAS system configuration consistent with certain embodiments of the present invention.

FIG. 3 is a flow diagram for data import into the system consistent with certain embodiments of the present invention.

FIG. 4 is a flow diagram for building and/or updating one or more dictionaries for use by the system consistent with certain embodiments of the present invention.

FIG. 5 is a flow diagram for word tokenization and analysis consistent with certain embodiments of the present invention.

FIG. 6 is a flow diagram for machine language preprocessing to build training data sets consistent with certain embodiments of the present invention.

FIG. 7 is a flow diagram for training data processing and use consistent with certain embodiments of the present invention.

FIG. 8 is a flow diagram for machine language field definition and update consistent with certain embodiments of the present invention.

FIG. 9 is a flow diagram for selection and use of machine language algorithms during analysis of incoming dictionaries consistent with certain embodiments of the present invention.

FIG. 10 is a view of a knowledge graph data table used in data analysis consistent with certain embodiments of the present invention.

FIG. 11 is a view of a multi-criteria, decision making table consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

Data is considered to be a set of values of subjects in a digital format that is storable and transmissible by computer systems.

The database is an ordered collection of data stored in a digital format on a computer system. Databases are maintained by database management systems (DBMSes). Queries to some databases are codified in the Structured Query Language (SQL).

The programming language is a formal language which comprises a set of instructions that produce various kinds of output. Programming languages are used in computer programming to implement algorithms.

The operating environment is composed of the operating system, communications software, software utilities, and platform software necessary for users to run application software.

The computer system is a set of devices that execute computational operations, store data used for input to computational operations and which are generated from computational operations, and transmit and receive data to and from other computer systems.

The use of lemma in this document refers to a heading indicating the subject or argument of a literary composition, an annotation, or a dictionary entry.

The use of Machine Learning (ML) in this document refers to one or more learning systems capable of identifying and processing fields in unknown input data to classify and predict the future state of the input data upon being trained in the definition and analysis of one or more training data sets by one or more human users.

By using interactive and iterative programming techniques coupled with machine learning and multi-criteria decision-making algorithms, an Intelligence Augmentation System (IAS) has been developed to assist users in optimizing text processing, quantitative analysis, and decision support.

In an embodiment, many analytical applications have the capability of analyzing aggregate views of data but are unable to perform analytics requiring real time join functions between different data tables and allow the user to see the results of analysis under these dynamic conditions. The opportunities in “Big Data” are the fusion of these data sets, however most database systems require complex join functions and extensive understanding of structured query language (SQL) to derive analytics and insights from the aggregate data views. This application describes an easy to use user interface that allows users to perform these tasks.

Unstructured text data mining is often used by business intelligence organizations to capture public perceptions regarding products, events, etc. by analyzing textual data input to the system. In non-limiting examples, such text data mining has been used in healthcare to extract information from electronic medical records, and in law enforcement to extract information regarding crimes. The challenge of Unstructured Text Analytics in data mining of text is the ambiguous nature of language. Each domain such as healthcare or crime requires intensive input from the subject matter expert (SME) in order to be effective. An SME may develop the lexicon required by the machine to perform the data mining task on unstructured data.

In an embodiment, Business Intelligence and Decision Making requires a broad range of factors in determining outcome. The use of machine learning algorithms for unstructured and structured data analysis may provide one or more objective measures of the data aggregated and isolated by the machine. However, the use of machine learning algorithms does not take into account the various weights of the features studied. While the statistical approach may be used to derive the factors that influence the outcomes of the features under investigation, a decision is the aggregation of multiple features. A Machine Learning (ML) model may inform a business what to sell in a given store but it will struggle with determining what market to expand into. This type of open-ended scenario planning requires a methodology for collecting features and adjusting weights. In a non-limiting example, a weighted order decision process needs to be coupled to the analytics engine to provide such features.

Businesses often have data in many digital formats within their organizations. These data are often stored in databases, text documents such as Word, or in spreadsheets such as Excel. Aggregating this information usually requires the resources of a person with expertise in data transformation to convert all the disparate data types into a common data format that allows the user to explore relationships. In a non-limiting example, a database may contain information about a customer, such as purchase history while another database within the company may contain data about all co-purchases such as, if a customer buys one item, what else do they buy at the same time. To develop a targeted ad campaign the company may want to couple the personal purchase data with any co-purchase data. Accomplishing this coupling would require the development of a new database schema and query which may be beyond the expertise of a business person. The system described herein allows the business person to perform this task then analyze the results without the need of a programmer.

In addition, if the business person had a long list of co-purchases to present to purchasers, the selection captured and presented by an ML algorithm to a user of the system may help determine the item most likely to appeal to the customer. The query system built into the IAS feeds data into a series of machine learning algorithms such as Feature Selectors, Support Vector Machines, or Neural Networks that inform the user, such as the previously identified business person, of possible correlations along with the potential likelihood of error surrounding each recommendation.

In an embodiment, if the business person wants to capture what is being reported in social media or the news about his/her product, the IAS performs Unstructured Text Analytics on data captured on the web and stored in the system. Using the Text Processing and Analytics Function the user simply develops one or more dictionaries containing a few words specific to a given topic. In a non-limiting example, the user may provide words specific to whether the customer “likes” the product. The dictionary function uses a built-in thesaurus to find synonyms to “like”, searches the document and asks the user if the terms in the context of how they appear in the document should be added to the dictionary. Adding such new terms to one or more dictionaries prepares the IAS to expand the repertoire of recommendations to subsequent users of the system.

In addition, the document may be parsed and the words in the document may be labeled with part of speech, with subsequent phrase generation and comparison to the one or more dictionaries. Combinations of phrases with dictionaries are used to train ML algorithms (such as LDA and neural networks). The system then passes recommendations as sentences with terms of interest back to the user.

Decision-Making includes factors that often are ambiguous or represent unarticulated preferences.

In an embodiment, the IAS comprises six major components. The first of these encompasses the data capture for use by the system. Data exists in many formats, such as text documents (multiple formats; xdoc, txt, csv, html, web crawls) binary files (PDF), or in structured data formats (databases, xml) that enumerate relationships between data fields and elements. In the IAS system, data stored on local networks or available on the web can be accessed by the IAS system when proper communications are established and data access is by default, such as publicly available data or open data access, or data access is granted by the owner of the data. The data connector to establish the communication and access the required data is built into the system and uses the appropriate database connectors for relational databases and additional pre-configured data connectors for other data types. The system when deployed is configured so that network system administrators provide access to databases, data stores, and file systems.

In an embodiment, for text analysis Data Tables stored in a Data Store can undergo the analysis of input text through the process of text analytics. The intent of text analytics is to extract facts from textual data or to classify text as meeting conditions defined by the user. Text, unlike quantitative data, has a high degree of ambiguity because of the contextual meaning of words. The innovation set forth in this document describes a process where users “seed” the dictionaries with a set of terms, the system compares the terms to a thesaurus, extracts sentences from the corpus of documents and requests feedback. In addition, the system uses machine learning algorithms to supplement the thesaurus resulting in improved specificity and context with relatively low SME input. To improve context and specificity, the integrated system text tool integrates data preparation, novel approaches to dictionary supplementation, and machine learning to provide contextually relevant fact extraction and classification of documents.

Selection of Natural Language Processing on the home page provides the functionality for implementing Natural Language Processing. Natural Language Process workflow offers the user two choices, a rules-based system using dictionaries, or machine learning. In a rules-based system, the system is directed by the user to annotate the document using the dictionaries developed using the Dictionary Editor. The advantage of a rules-based system is that the system will only annotate what has been defined as a term of interest, this term of interest becomes a dictionary term.

In a non-limiting example, to overcome the need for programmers to develop the code necessary for performing the task of annotation, the users are directed to a Dictionary Matrix Table where a data table with its respective fields may be displayed as rows, while each dictionary is displayed as a column. The user simply selects which dictionaries should be matched with which fields. The selection process has the option to be global (all dictionaries, all columns). Following the selection process, the annotation process is initiated and the machine annotates the data in the data table. Output is an index associated with the data table stored in a data store.

The second feature is the intelligence augmentation system deployed for utilizing machine learning. The IAS provides a multifaceted approach to utilizing machine learning that makes use of a feedback loop based on a rules-based system to improve the specificity and context of returns generated by the machine learning algorithms. The concept is that the use of dictionaries supplemented with the thesaurus feedback tool isolates facts and/or content of relevance. The identified facts and/or content become the training data for the machine learning algorithms.

The system generation of training data can be a tedious, time consuming process requiring manual annotation of documents. To overcome this issue, the system utilizes the output from a rules-based system coupled with part of speech (POS) analysis to generate phrases that have the appropriate specificity and context for the domain under investigation. The dictionaries provide the specificity, use of POS improves context as placement of terms in noun-verb-noun relationships uses rules of grammar to improve the relevancy of the terms that are used as either positive or negative training data in the machine learning models. These activities are performed on specific fields selected from the cleaned text, where cleaned text consists of known text fields and known contextual references for the text fields.

In an embodiment, the machine-learning learning system included with the IAS provides the user with information concerning topics that were not readily apparent to the user. In a non-limiting example, if the user developed dictionaries that isolated phrases that contained information concerning demographics and purchases, the rules-based system may retrieve facts such as “single males that purchase skateboards” if the noun for the verb purchase was restricted to skateboard and skateboarding items. The machine learning model may return a list of potential purchase items including skateboards but would expand that list to possible items contained in the documents such as cars, music, etc. that may be contextually relevant to those individuals that have historically purchased skateboards. The user can then request that one or more of the newly presented potential purchase items be added to the data table.

The text tools deployed with the IAS enable the user to develop models for fact extraction and text classification without a deep understanding of programming. The system relies on the user's expertise in the field to initiate the process and provide feedback to develop models for data extraction and text classification. The system is vertical agnostic and can be used by any subject matter expert.

In an embodiment, the IAS can perform classification and prediction calculations of user data through instantiating a series of algorithms that may be provided inputs generated by the preprocessing routines. The preprocessing routines receive input from a feedback system consisting of a user interface, the data under investigation, and the aforementioned routines. In addition, the system must be informed if the data model required is supervised or unsupervised learning. The user is prompted to characterize the query. Once filtering is complete and data visualized, the filtered data can be sent to directly to the machine learning algorithms.

This user input allows the IAS to select the appropriate set of machine learning algorithms to apply to the problem. The data is organized as a series of columns. The selection of a column represents the value a user wants to classify and/or predict without showing how the other data columns or features contribute to the analysis/prediction. This data isolation leads to the application of supervised learning algorithms where a selection of one column of data while requesting data grouping in an attempt to cluster data “likes”, where a “like” may be a similarity between two fields or data groups that permits the analysis of data to be performed more efficiently, may direct the system to supervised or unsupervised learning algorithms to optimize the processing of the data without requiring programmer intervention.

In an embodiment, the IAS has a GUI that allows non-programmers to develop queries of structured and unstructured data processed by the IAS algorithms.

The system employs a user interface to direct the user to add data analysis functions called widgets to the display using simple drag and drop user interface cues.

The configuration of the data display is referred to as a dashboard. Each dashboard is associated with a primary data table in the data store. During the data import process, the system may automatically import key relationships that exist in database tables and the system may allow the user to define new relationships in data tables imported into the IAS. Automatically importing key relationships increases the user's ability to define relationships between data sets without the need of a programmer.

In an embodiment, the system has the ability to generate knowledge graphs through the use of the dashboard application. Knowledge Graphs are useful in the visualization of relationships between entities. The Knowledge Graphs can also display distance relationships between entities. In a non-limiting example, the system uses the ability of NoviLens, a natural language processing capability native to the IAS, to filter data through the NLP annotation process and Machine Learning algorithms that may provide the data tables for the widgets. This function takes the filtered results and via a user interface, prompts the user for relationships between features.

In an embodiment, the objective extraction and analysis of facts addresses many of the activities required by business analysts. However, there is a need for a somewhat subjective methodology in determining prioritization of decision making. In a non-limiting example, the decision on what automobile to buy may be driven by different priorities depending on the purchaser. A family of six has different requirements than a single person with regard to seating capabilities. A framework to manage these decision priorities has been built into the IAS system. This model uses the NLP and filtering capabilities of the IAS to collect and isolate the necessary facts. The IAS may then apply a series of weighted order decision algorithms to the data. Another unique feature is the user interface that allows the user to determine categories and scores as well as weights, then run “what if scenarios” to determine how changing preferences can change outcomes.

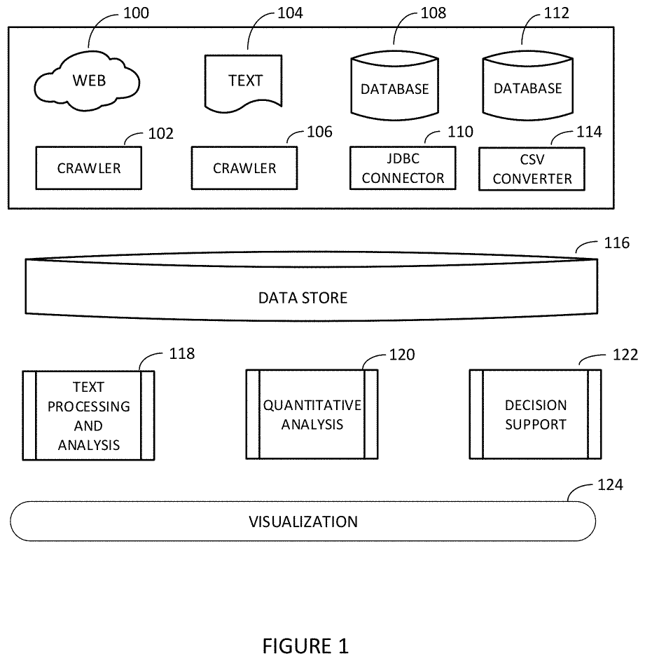

Turning now to FIG. 1, this figure presents a view of an Intelligence Augmentation System (IAS) features consistent with certain embodiments of the present invention. In an exemplary embodiment, the IAS accesses data from a number of online and network connected data repositories to import the data into the system for processing and analysis. In non-limiting examples, data may be sourced from the web 100 through the use of a web crawler 102, access data from text documents 104 through the use of a text document crawler 106, access data from relational database files 108 through the use of a database connector 110 with permission from the owner of the database files 108, and access comma separated value (csv) database files 112 through the use of a csv converter 114, again with the permission of the database file owner. This list of data sources may in no way be considered the only data sources from which the IAS may derive input data for analysis and processing. Additional data sources may be accessed through the use of additional data access methods.

In an embodiment, the incoming data from all data sources may be normalized and processed to be added to one or more data stores 116. A data store may be selected by a user for text processing and analysis 118 to discover textual data that conforms to one or more conditions expressed by a user for analysis. The data in the data store may also be accessed for quantitative analysis 120 and processed for decision support 122, again based upon parameters input and established by a user. After processing by any or all methods is complete, the processed data from the data store may be formatted for visual presentation 124 to the user.

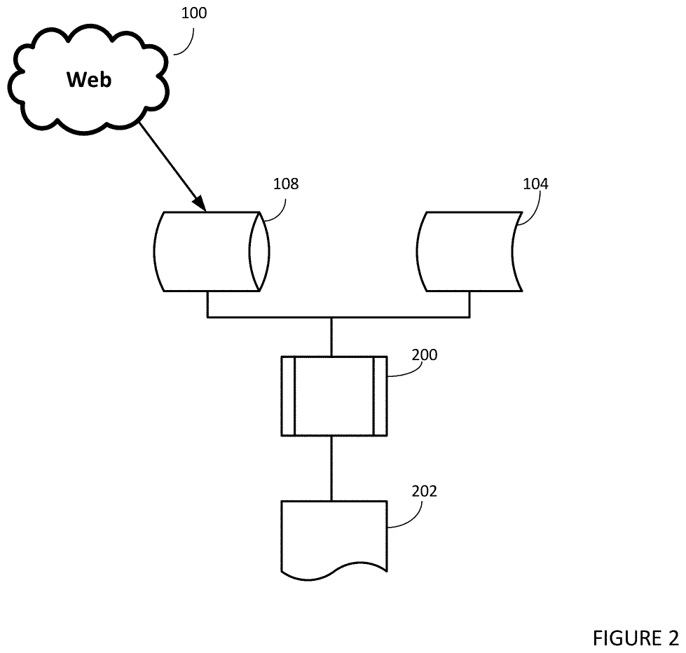

Turning now to FIG. 2, this figure presents a view of the IAS system configuration consistent with certain embodiments of the present invention. In an exemplary embodiment, the system presents a novel method to overcome the need for programming, the system user interface 200 is based on the NoviSystem advanced data modeling system (ADMS), consisting of a high level programming function utilizing an object reference model that translates the criteria of data analysis established by the user into automatically generated processing steps in the form of SQL commands. This innovation results in the generation of a data table 202 that becomes the source of data for analytical queries and/or further data processing. The use of the ADMS provides flexibility in user functionality. Queries do not need to be designed to be domain specific. Rather, the model can be adapted to the data set that is being imported regardless of whether the data was imported from formats such as text, csv records, database records, or any other pre-established data file format. Furthermore, while a classic static database query system may require predefined primary and foreign keys to be maintained and may limit the ability to fuse multiple data sources, this approach allows disparate data types to be joined. The data generated as the new Data Table 202 is stored in a relational database.

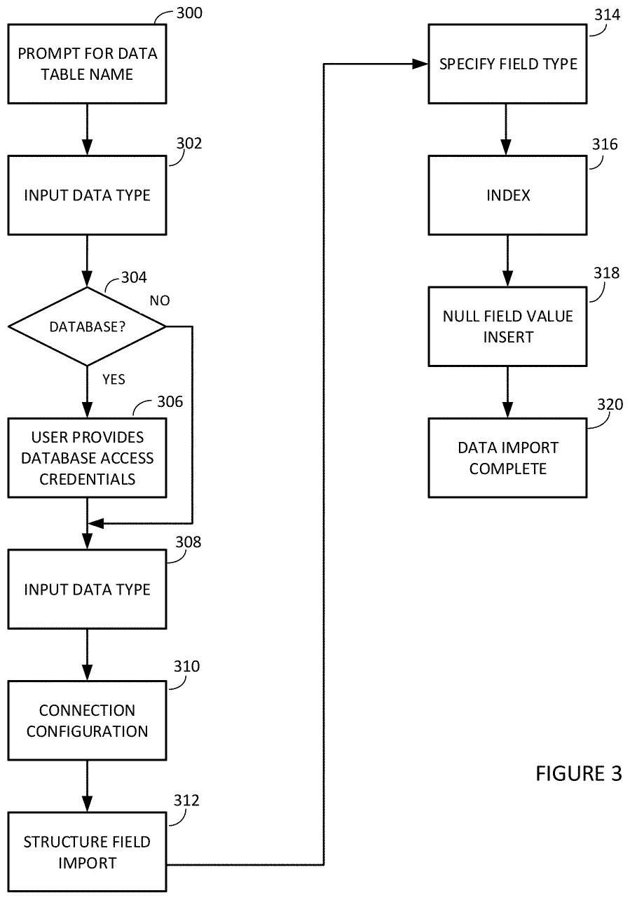

Turning now to FIG. 3, this figure presents a flow diagram for data import into the system consistent with certain embodiments of the present invention. In an exemplary embodiment, during the import process, the user is first prompted for a Data Table name 300 then the data type 302. If the data type is a database 304, the user must provide the appropriate credentials to connect to the database 306. If the data type is a data type other than a database such as, in a non-limiting example, a text document, csv data, or any custom data type, the user must enter the data type 308.

Once the connection is configured and established 310, the database or file(s) will be read and the system will structure the data into a series of fields (columns) 312. The user will then be shown the list of fields on the user interface and be asked to specify the field type using a drop-down menu 314. The possible selections may include numeric, float, date, and text fields as well as custom defined fields that may be pre-configured by a user of the system. In order to increase system performance, each field can be indexed 316. The user can choose between a normal index and a Full Text index. The acceptance of null fields can be configured using the null parameter 318 where the acceptance is a toggle value of yes or no. Upon generation of data type, field type, and the treatment of null fields, the data is indexed in compliance with the user selection and the data import is complete 320.

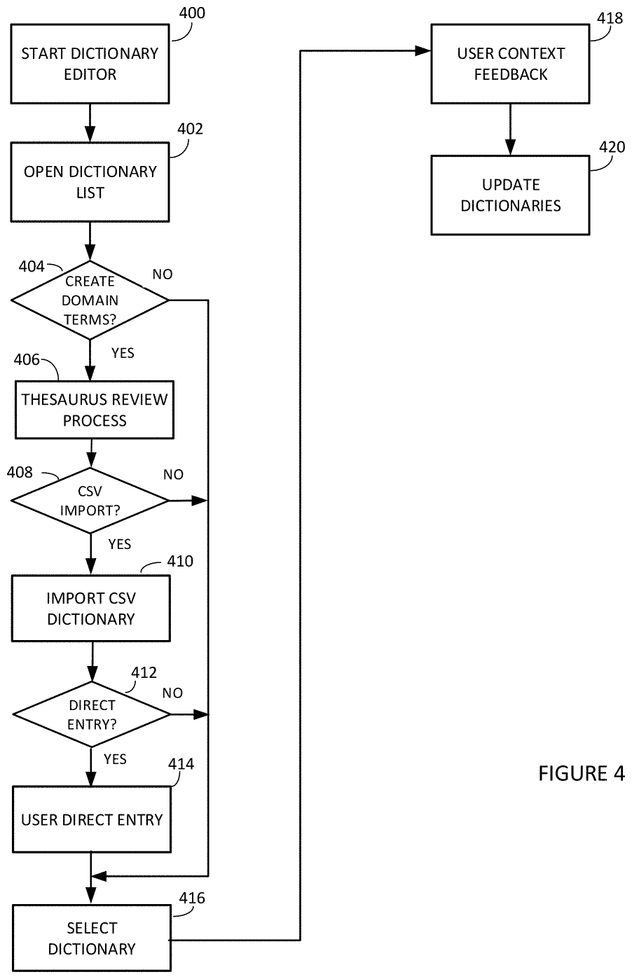

Turning now to FIG. 4, this figure presents a flow diagram for building and/or updating one or more dictionaries for use by the system consistent with certain embodiments of the present invention. In an exemplary embodiment, the dictionary editor sub-process begins by the user selecting the Dictionary Editor 400 on the GUI home page. This opens a listing of the dictionaries available in the application 402. A dictionary is a collection of terms that have a similar meaning, for example, positive sentiment would use a dictionary of terms associated with “good” such as good, great, excellent, etc. The user can create a new dictionary 402 by requesting that the system suggest terms of importance 404. If the user selects the option to have the system create domain terms by suggesting terms of importance 404, the system will submit the selected domain terms to a thesaurus review process at 406 to maintain language accuracy for selected terms. The system also may inquire of the user at 408 whether the system is to import a list of terms from a csv file. If the user selects this option, the system may import a list of terms from a csv file 410. Selecting csv import opens a new window and that allows the user to browse the file system and select a preconstructed csv file containing terms of interest. Once selected, the file is imported. The user may also, alternatively or in conjunction with the imported csv file select direct entry of terms at 412. If the user selects the option to enter terms directly, the system provides a data entry capability to permit the user to enter the terms and/or word(s) 412 in the spaces provided.

Dictionaries can be edited by selecting the dictionary in the GUI. The development of dictionaries can be a tedious process. To improve the efficiency of the process, selecting a dictionary 416 provides the user with several options; viewing suggestions, view raw data, or delete.

Selecting suggestions initiates the thesaurus review process where the terms in the dictionary are compared to a thesaurus contained in the application. The synonyms, hyponyms, and hypernyms are then annotated in the data table along with the original dictionary terms. A sample of the sentences containing the original terms and synonyms and are presented to the user. The user can then review these sentences and determine if the context of the terms is appropriate and provide guidance as to appropriate terms as feedback to the system 418. If appropriate, the terms are added to the dictionary 420. The thesaurus process functions on textural data using a series of algorithms that are python-based but can be deployed using java.

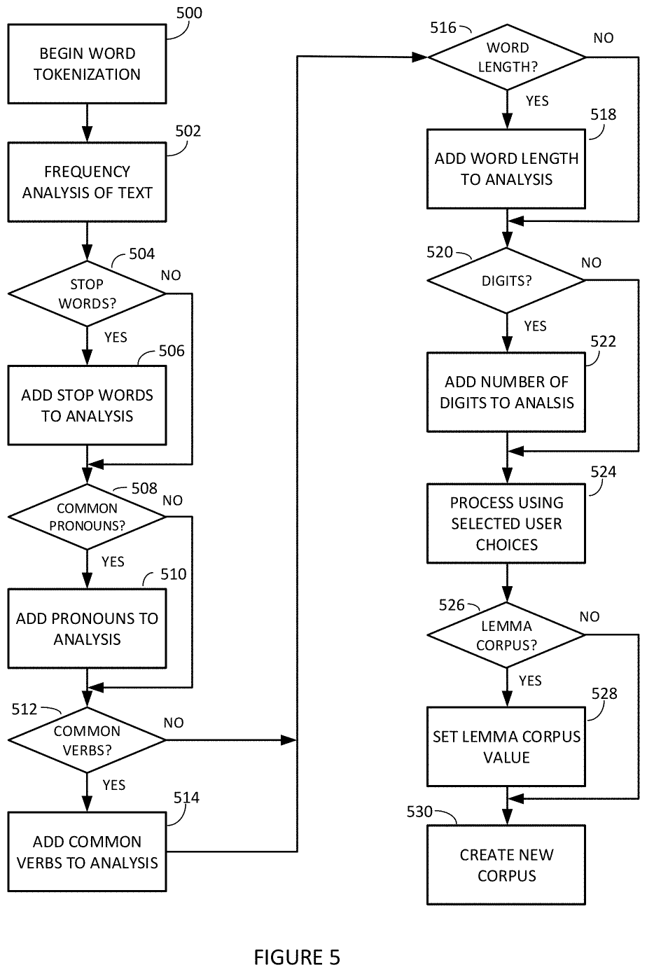

Turning now to FIG. 5, this figure presents a flow diagram for word tokenization and analysis consistent with certain embodiments of the present invention. In this embodiment, the system begins with processing text fields to tokenize words in any imported Data Table. The objective of the text cleaning process is to reduce the number of irrelevant words, terms that have no impact on context or specificity, so that the data set is reduced in size leading to more efficient operation and a greater probability of relevant returns.

The first step in the process is word tokenization 500. This breaks down the structure of the text data from continuous strings to individual tokens. When tokenization is complete the system performs frequency analysis 502 of the tokenized text using nitk or other suitable programming tools. This frequency value for each tokenized word may be stored for later use.

At 504, the system asks if stop words should be included in the analysis. If the user indicates that they should, stop words are included in the analysis by comparing word frequency values to stop word frequency at 506. The user is also presented with choices by the system to include common pronoun frequency at 508 and common verb frequency at 512. If the user elects to include common pronouns and common verbs in the analysis, common pronouns are added to the analysis at 510 and common verbs are added to the analysis at 514.

Two additional cleaning steps may be performed if selected. At 516 the user is asked if word length should be included, and, if elected by the user, the system removes any word less than four letters long with the exception of abbreviations at 518. At 520 the user is asked if digits should be removed and, if elected by the user, the system removes a selected number of digits from the analysis at 522. The system processes the Data Table utilizing the user specified selections at 524 to create a new corpus. At 526 the system asks the user if the new corpus should be created using the lemma. If the user elects to create a lemma corpus, at 528 the system sets the lemma corpus value, and the new corpus, regardless of type, is created as the basis corpus at 530 and can then be used as the basis for machine learning.

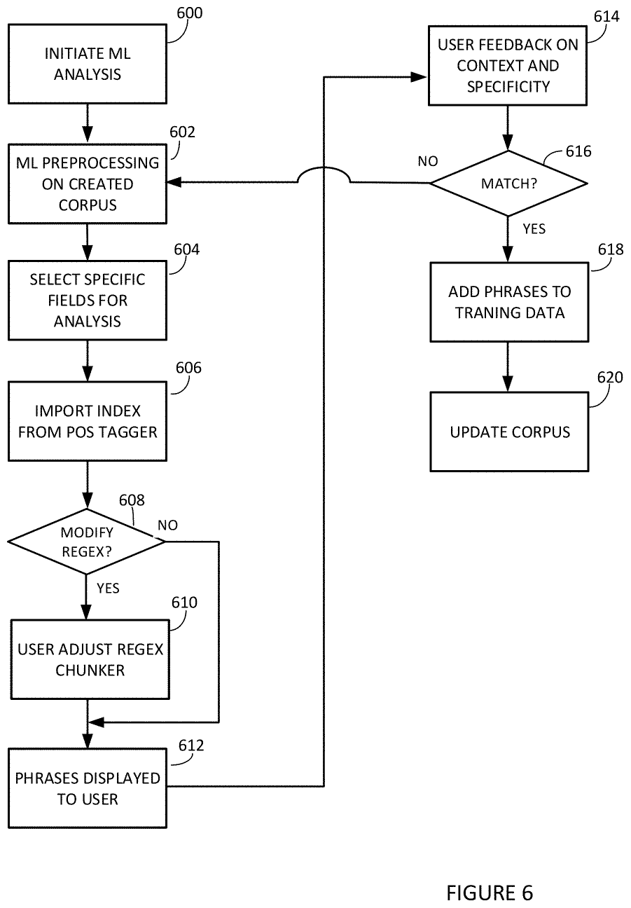

Turning now to FIG. 6, this figure presents a flow diagram for machine language preprocessing to build training data sets consistent with certain embodiments of the present invention. In this embodiment, the system initiates ML analysis at 600 by performing preprocessing steps on the previously created corpus at 602. The system selects specific fields for analysis at 604 and imports the necessary index from a POS tagger at 606. The system then ingests specific fields of cleaned text and the index from the POS tagger. At 608 the system inquires if the user wants to modify the regex. If the user selects this option, at 610 phrases are then generated using a regular expression chunker (nltk or similar algorithm). The system has default regular expression chunker but it can be adjusted by the user. Phrases are displayed to the user at 612 in order to receive user feedback on specificity and context at 614.

Following acceptance of the phrases, the POS tagging process is performed on either the lemma derived corpus or basis corpus. Terms from the phrases are compared to terms in the dictionaries for matching values at 616. One term from any dictionary must be present in a phrase. If there is a match, the phrase will be added to the training data at 618. At 620, the system updates the corpus and the updated corpus may be used in the machine learning algorithm for training.

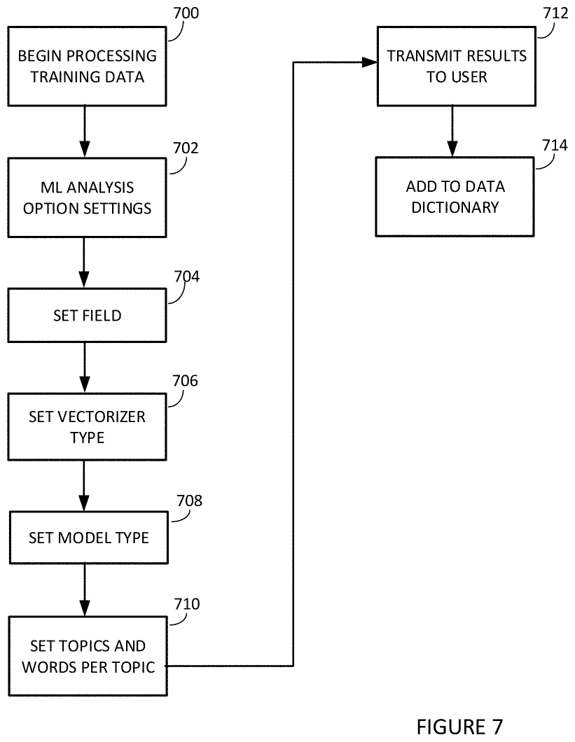

Turning now to FIG. 7, this figure presents a flow diagram for training data processing and use consistent with certain embodiments of the present invention. In this embodiment, the IAS uses multiple machine learning algorithms to process training data. The system may use a number of algorithms including but not limited to Latent Dirichlet Allocation (LDA), Non-Negative Matrix Factorization (NMF), and Neural Networks (NN). Machine Learning begins with processing the training data 700.

Users of the IAS are instructed to select analysis options from the user interface 702. The user may select the field to be analyzed at 704 and the vectorizer type may be selected at 706. Vectorization converts the text to a numerical array for use in the machine learning algorithms. The vectorizer type can either be a word to vector transformation or term frequency-inverse document frequency vectorization.

Following vectorization, the model type may be selected by the user at 708. This determines the clustering algorithm that will be run. The selection includes LDA, NMF, and NN as described above. At 710, the user may select the number of topics and the words per topic to be processed by the system. In a non-limiting example, the number of topics represents the number of clusters or topics that will isolated by the machine learning algorithm. If the user asks for three topics, the returns will provide a list of terms in clusters that represent terms that cluster in three separate groupings.

This list is compared to the dictionaries and new terms or topics are presented to the user 712. The user can then elect to add the terms to a new dictionary or append the terms to an existing dictionary 714.

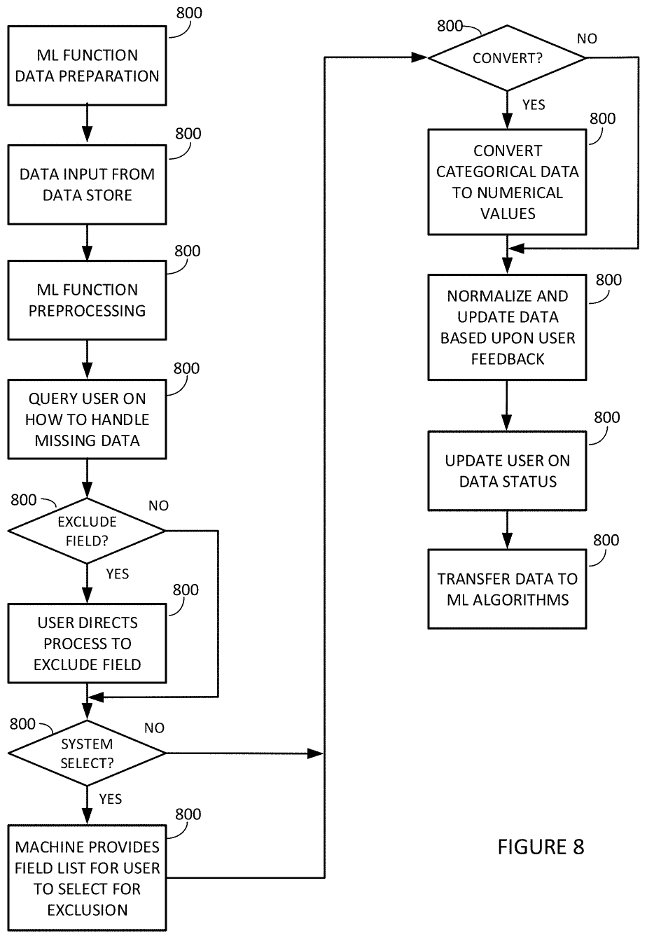

Turning now to FIG. 8, this figure presents a flow diagram for machine language field definition and update consistent with certain embodiments of the present invention. In this embodiment, the quantitative ML module in IAS 800 initializes operation by preparing the data to be analyzed for ingestion. At 802, the ML module operation begins with data ingestion from the data store. The incoming data table is assessed at 804 by the preprocessing algorithm that determines the following: the feature names of the table, the number of feature values missing, and the statistics of the table. At 806, the IAS system then queries the user regarding data conversion where input is requested for how to handle missing data, should select features be deleted, or if the user wants the machine to determine if features can be deleted.

For missing field processing, at 808 the system provides the user with the option of either deleting the row of the table containing the missing data or using the mean value of the data for the feature. If the user directs the system to exclude the field, at 810 the IAS excludes the field by deleting the table row containing the missing data. The IAS at 812 asks the user if the system should recommend fields for exclusion. If the user selects this option, the system recommended feature selection is performed using a series of algorithms that evaluate each feature for its variance at 814.

Additional preprocessing feedback is required where select features data types may need to be converted from text to digits at 816. This is true for categorical data such as names of States, or the gender of an individual. If the value can be fit in a category or is binary, that is, yes or no, male or female, friend or enemy, the system will ask the user if it should be converted for analysis. At 818, if conversion is requested, the conversion algorithm is performed.

Once preprocessing is complete on the selected data, at 820 the data is normalized using a statistical algorithm. At 822, the user is informed that the data is ready for processing in the machine learning system. The user must then inform the system if the intent of the analysis is the classification of a value or the prediction of a continuous value. Upon receipt of the user intention for the desired analytical intent, at 824 the system transfers the normalized and updated data to the ML algorithms for processing.

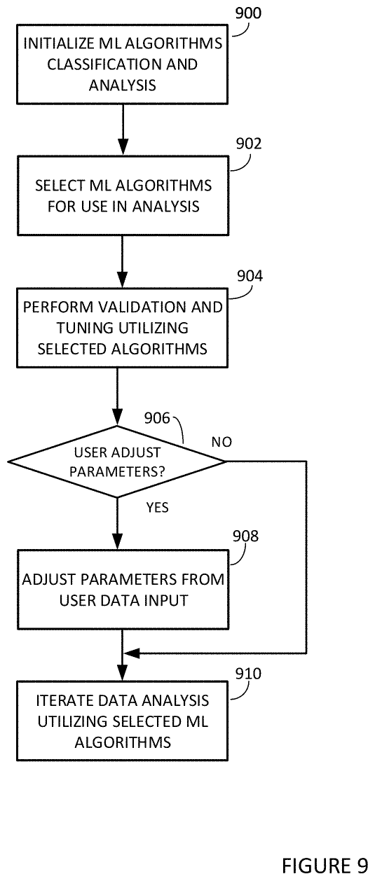

Turning now to FIG. 9, this figure presents a flow diagram for selection and use of machine language algorithms during analysis of incoming dictionaries consistent with certain embodiments of the present invention. In this embodiment, at 900 the machine learning classifiers make use of a series of open source algorithms where the IAS has developed a user interface that allows a non-data scientist to perform classification assessments on data. Unique to the IAS is the interplay between the user and the ML algorithms selected by the user for performing the analysis of the data 902. The system can incorporate other algorithms as models are developed.

Each classifier is programmed to self-tune based on the input from the user and the attributes of the data, if the user has informed the system that the algorithms are known. The input from the user directs algorithm performance.

Following the selection of the machine learning algorithm, each algorithm performs a validation and tuning step 904 to determine the suitability of the data to provide reliable results with regard to sample size (if appropriate) and parameter selection (autocomplete parameter table).

At 906, to address the needs of advanced users, the system does have the capability to have parameters of each machine learning algorithm to be individually adjusted. If the user selects this option, at 908 the user is presented with a user interface represented as a table for each machine learning algorithm to permit the user to enter adjustment values. For example, a table for the parameters associated with the Random Forest classifier may be used and then direct the IAS to rerun the analysis of the data 910.

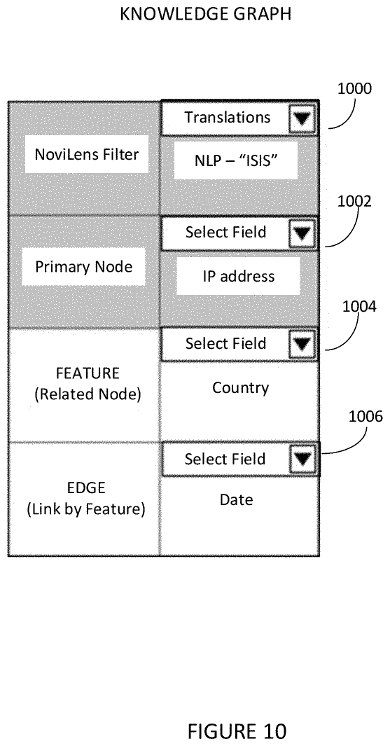

Turning now to FIG. 10, this figure presents a view of a knowledge graph data table used in data analysis consistent with certain embodiments of the present invention. In this embodiment, the user selects a filtering function based on a “widget” query 1000. Through a series of drop-down menus, the user then selects the relationships that are to be established. The first is the Primary Node 1002 or the central feature that is the initiation point of the relationships. The user then selects the adjacent feature 1004 via a dropdown menu. These two features need to be linked by a relationship in the data table; this is the edge value, selected as another column from the data table 1006. The result is a visualized graph of the relationship between the various features selected. This, in turn, can be filtered via a query widget.

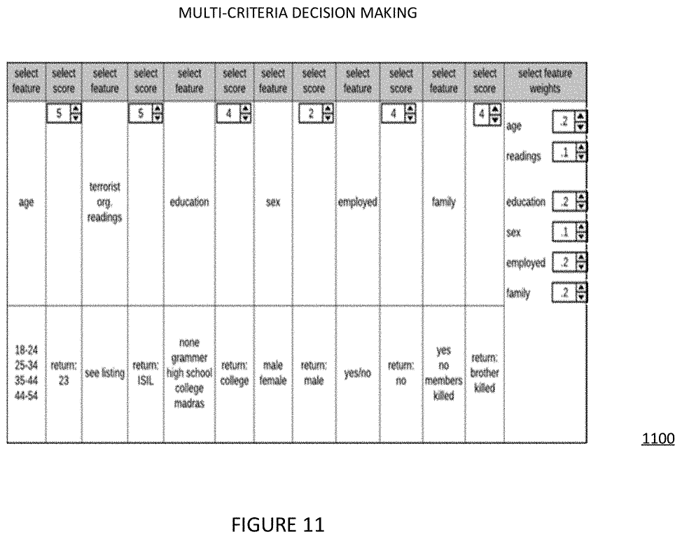

Turning now to FIG. 11, this figure presents a view of a multi-criteria, decision making table consistent with certain embodiments of the present invention. In this embodiment, The Multi Criteria Decision Making system 1100 uses a series of open source algorithms to calculate the difference between the features in a group depending on either the ideal maximum or minimum value or how they relate to each other. The user interface consists of a table-like structure that self populates features selected by a NoviLens widget created and managed by the IAS. The user then enters a score for each widget and inputs the relative weights associated with each of the features. The algorithms are executed and a rank order or score is generated for each entry in the model.

An additional feature is the ability of the user to create category scores for each feature through a secondary interface. This step allows the machine to score all the returns generated by the search widget.

While certain illustrative embodiments have been described, it is evident that many alternatives, modifications, permutations and variations will become apparent to those skilled in the art in light of the foregoing description.

What is claimed is:

1. A system for dynamic decision support, comprising:
a system server having a Graphical User Interface (GUI) active to receive a query associated with a problem requiring decision support from a user;
receiving at said server data from multiple external data sources;
initializing a module in said server to normalize received data into a dictionary matrix table and storing said normalized data in a data store maintained within said system server;
the user selecting fields and dictionaries to be annotated where a module is active within said system server to annotate all selected fields and dictionaries, create a data index, and store said selected fields and data index in a data store;
initializing one or more text analysis tools within said server selected by a user to create one or more models for data extraction and text classification;
in response to a server prompt to the user, the user inputs a query classification;
performing data filtering within the system server through operation of one or more selected classification algorithms to create filtered information according to said query characterization;
transmitting said filtered information to one or more Machine Learning (ML) algorithms to address the problem expressed in said user query;
the one or more ML algorithms selected applying said one or more models to the filtered information to collect and isolate facts to assist a user with decision priorities for the problem expressed in said query.

2. The system of claim 1, where data from multiple sources is data from web, text, data base, comma-separated-value (csv), or any other common formatted data source.

3. The system of claim 1, further comprising a dictionary editor module active to receive user feedback associated with input data content.

4. The system of claim 1, further comprising text analysis tools associated with word tokenization, word frequency analysis, stop word existence, common pronoun selection, common verb selection, and word length for selection by the user in performing text analysis on received data.

5. The system of claim 1, further comprising instantiating one or more selected ML algorithms to create training data for use in characterizing received unknown data from one or more data sources.

6. The system of claim 5, where the selected ML algorithms present selected text phrases to a user and receive user feedback regarding context and specificity of said selected text phrases to address the query.

7. The system of claim 6, where the user feedback indicates a match, the selected text phrases are added to the training data set and stored to the data store maintained by said system server.

8. The system of claim 1, further comprising utilizing training data sets maintained by the system server to process received data for proper data classification of said received data.

9. The system of claim 1, further comprising transmitting from said ML algorithms to the user a query on how to handle data that is determined to be missing from a data set, receiving a response from the user, and normalizing and updating said data set based upon the response from said user.

10. The system of claim 1, further comprising performing validation and tuning of each data set utilizing selected ML algorithms, receiving user feedback to adjust parameters of analysis, said ML algorithms adjusting parameters of analysis, and performing additional validation and tuning of each data set utilizing said user feedback.

11. A method for dynamic decision support, comprising:
receiving a query associated with a problem requiring decision support from a user;
receiving data from multiple external data sources;
normalizing said received data into a dictionary matrix table and storing said normalized data in an electronic data store;
the user selecting fields and dictionaries to be annotated;
annotating all selected fields and dictionaries, creating a data index, and storing said selected fields and data index in said electronic data store;
creating one or more models for data extraction and text classification utilizing one or more text analysis tools selected by a user;
receiving a query classification from the user in response to a server prompt to the user;
one or more selected classification algorithms performing data filtering to create filtered information according to said query characterization;
transmitting said filtered information to one or more Machine Learning (ML) algorithms to address the problem expressed in said user query;
the one or more ML algorithms selected applying said one or more models to the filtered information to collect and isolate facts to assist a user with decision priorities for the problem expressed in said query.

12. The method of claim 11, where data from multiple sources is data from web, text, data base, comma-separated-value (csv), or any other common formatted data source.

13. The method of claim 11, further comprising a dictionary editor receiving user feedback associated with input data content.

14. The method of claim 11, further comprising text analysis tools associated with word tokenization, word frequency analysis, stop word existence, common pronoun selection, common verb selection, and word length for selection by the user in performing text analysis on received data.

15. The method of claim 11, further comprising the one or more selected ML algorithms creating training data for use in characterizing received unknown data from one or more data sources.

16. The method of claim 15, where the selected ML algorithms present selected text phrases to a user and receive user feedback regarding context and specificity of said selected text phrases to address the query.

17. The method of claim 16, where the user feedback indicates a match, the selected text phrases are added to the training data set and stored to the data store.

18. The method of claim 11, further comprising utilizing training data sets to process received data for proper data classification of said received data.

19. The method of claim 11, further comprising transmitting from said ML algorithms to the user a query on how to handle data that is determined to be missing from a data set, receiving a response from the user, and normalizing and updating said data set based upon the response from said user.

20. The method of claim 11, further comprising performing validation and tuning of each data set utilizing selected ML algorithms, receiving user feedback to adjust parameters of analysis, said ML algorithms adjusting parameters of analysis, and performing additional validation and tuning of each data set utilizing said user feedback.
